(19) United States
(12) Patent Application Publication
(10) Pub. No.: US 2016/0092642 A1
(43) Pub. Date: Mar. 31, 2016

(54) Determining Orphan Drug Eligibility for Reduced Pricing

(71) Applicant: MCKESSON CORPORATION, San Francisco, CA (US)

(72) Inventors: Andrew Maurer, Atlanta, GA (US); Soranarom Kumsaitong, Alpharetta, GA (US); Richard Selby, Duluth, GA (US)

(21) Appl. No.: 14/500,472

(22) Filed: Sep. 29, 2014

(51) Int. Cl. G06F 19/00

(52) U.S. Cl. CPC G06F 19/328; G06F 19/322; G06F 19/3456

(57) ABSTRACT

Systems, methods, and computer-readable media are disclosed for determining whether an orphan drug is eligible for replenishment at a 340B price for the drug by evaluating orphan drug identification data, patient encounter data, and/or dispensing data with respect to one or more eligibility criteria to determine whether the orphan drug has been prescribed, dispensed, or otherwise used to treat the rare disease or condition for which it is designated or an alternate condition.

### TECHNICAL FIELD

This disclosure relates generally to systems, methods, and computer-readable media for determining whether an orphan drug is eligible for replenishment at a reduced price, and more particularly, to systems, methods, and computer-readable media for determining whether an orphan drug is eligible for replenishment at a 340B price based at least in part on whether the orphan drug was used to treat an excluded disease condition for which it has been designated.

### BACKGROUND

Various government-sponsored and non-government-sponsored programs and entities exist for providing reduced costs for prescription products such as prescription medications, medical devices, and other prescription products. Such programs or entities may include, for example, the federal 340B drug pricing program, healthcare group purchasing organizations (GPOs), patient assistance programs (PAPs) available through pharmaceutical companies or governmental organizations such as Medicare or Medicaid, and so forth.

In 1992, Section 340B of the Public Health Service Act was enacted under Section 602 of the Veterans Healthcare Act of 1992. Section 340B requires drug manufacturers to provide outpatient drugs to eligible healthcare centers, clinics, and hospitals (referred to as “covered entities”) at a reduced price. This reduced price (sometimes interchangeably referred to as the “340B price,” the “Public Health Service (PHS) price,” the “602 price,” or the like) represents a maximum price that a covered entity is required to pay for select prescription drugs dispensed in accordance with the requirements of Section 340B and is often significantly lower than the Wholesale Acquisition Cost (WAC) price for such drugs.

A “covered drug” under the 340B program may include, for example, a U.S. Food and Drug Administration (FDA) approved prescription drug, an over-the-counter (OTC) drug that is written on a prescription, and so forth. Covered entities eligible to participate in the 340B program generally include entities that serve indigent or historically disenfranchised populations or that focus on treating particular disease conditions such as, for example, federally-qualified health centers, hospitals that treat indigent patients through a disproportionate share hospital (DSH) program, children's hospitals, free standing cancer clinics, family planning projects, state-operated AIDS Drug Assistance Programs (ADAPs), black lung clinics receiving federal funds, and so forth. Prescription drug purchases at the 340B price represent a significant cost savings over the typical costs for such drugs. The cost savings can, in turn, be passed on to patients, thereby reducing the overall cost of patient care to both healthcare providers and patients.

The Patient Protection and Affordable Care Act (“Affordable Care Act”) and the Health Care and Education Reconciliation Act (“HCERA”) enacted various changes to the 340B program. For example, the Affordable Care Act added new categories of covered entities including children's hospitals, free-standing cancer hospitals, critical access hospitals, and rural referral centers. The Affordable Care Act also amended Section 340(B) to exclude free-standing cancer hospitals, critical access hospitals, rural referral centers, and sole community hospitals from access to 340B pricing for a drug designated for a rare disease or condition, referred to as the “orphan drug exclusion.” A drug is designated by the FDA as “a drug for a rare disease or condition” pursuant to section 526 of the Federal Food, Drug, and Cosmetic Act (FFDCA) at the request of the sponsor if the FDA finds that the drug is being or will be investigated for a rare disease or condition and, if approved by the FDA, the approval will be for that disease or condition. This designation is referred to as the “orphan drug designation.” The orphan drug designation provides a number of incentives to encourage the development of orphan drugs which may otherwise not be developed due to a lack of commercial incentive.

The Department of Health and Human Services (HHS) has interpreted the orphan drug exclusion to only apply to an orphan drug when the drug is transferred, prescribed, sold, or otherwise used for the rare condition or disease for which the drug is designated. Accordingly, an orphan drug that is not transferred, prescribed, sold, or otherwise used for the rare condition or disease for which the drug is designated may be eligible for replenishment at the 340B pricing.

Because an National Drug Code (NDC) or other identifier for an orphan drug may not be readily determinable (e.g., may not be provided by the HHS, FDA, or other organization) and the corresponding designated condition may not be known by pharmacy staff, it may be difficult for a covered entity to determine when a drug is an orphan drug or to determine whether an orphan drug has been transferred, prescribed, sold, or otherwise used for the rare condition or disease for which it is designated. Thus, tracking orphan drug dispenses is difficult and runs the risk of non-compliance. Further, failure to identify orphan drug dispenses for treating non-designated conditions may result in lost opportunities to replenish the drug at a reduced price, and thus, lost savings.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic depiction of an illustrative system architecture in accordance with one or more example embodiments of the disclosure.

FIG. 2 depicts example hardware and software components of an illustrative computing device in accordance with one or more example embodiments of the disclosure.

FIG. 3 is a process flow diagram of an illustrative method for updating an orphan drug data record for an orphan drug in accordance with one or more example embodiments of the disclosure.

FIGS. 4A-4B are process flow diagrams of an illustrative method for determining whether an orphan drug is eligible for replenishment at a reduced price in accordance with one or more example embodiments of the disclosure.

### DETAILED DESCRIPTION

### Overview

Example embodiments of the disclosure relate generally to systems, methods, computer-readable or machine-readable media, techniques, and methodologies for determining whether an orphan drug is eligible for replenishment at a 340B price for the drug by evaluating orphan drug identification data, patient encounter data, and/or dispensing data with respect to one or more eligibility criteria to determine whether the orphan drug has been prescribed, dispensed, or otherwise used to treat the rare disease or condition for which it is designated or an alternate condition. An orphan drug may be a drug that has been designated for use to treat a rare disease or condition (referred to herein at times as a designated condition), but which may, under certain circumstances, be used to treat a different condition. A rare disease or condition may be any disease or condition that affects a small percentage of the population. The Orphan Drug Act, for example, defines a rare disease as one that affects fewer than 200,000 people in the United States. The terms disease and condition may be used interchangeably hereinafter.

If it is determined that a dispensing of an orphan drug occurred before the drug became effectively available for use to treat the designated condition or that the dispensing was related to a diagnosis for a condition other than the designated condition, the orphan drug may be determined to be eligible for replenishment at the 340B price as long as one or more other 340B eligibility criteria are met. In an example embodiment of the disclosure, one or more data processing servers (which may be referred to hereinafter as “orphan drug 340B eligibility determination server(s)”) may be provided for receiving various forms of input data such as orphan drug identification data, patient encounter data, dispensing data, or the like. The orphan drug 340B eligibility determination server(s) may analyze the input data to determine whether an orphan drug was used to treat a corresponding designated condition or an alternate condition and may generate output data indicative of this determination. If the orphan drug 340B eligibility determination server(s) determine that the orphan drug was used to treat a condition other than the designated condition, the server(s) may perform additional processing to determine whether other criteria are met for replenishing the orphan drug at the 340B price.

More specifically, in certain example embodiments, the orphan drug 340B eligibility determination server(s) may receive orphan drug identification data that may include, for example, a listing of orphan drugs and corresponding identifying information for each orphan drug. The identifying information may include, for example, a character string indicative of a name of the drug (a trade name and/or a chemical name); a character string indicative of a date on which the drug was designated as an orphan drug for use to treat a rare condition; a character string indicative of a name of a manufacturer of the drug; an indication of the designated condition such as, for example, a character string that provides a description of the designated condition or a diagnosis code corresponding to the condition; an indication (e.g., a Boolean flag) of whether the drug has been FDA approved; and so forth. The orphan drug identification data may be generated by a third party entity and received in any suitable format such as, for example, as part of downloadable file, a data feed, or the like. In certain example embodiments, a date of receipt of the orphan drug identification data may be an effective date for each orphan drug identified in the orphan drug identification data.

In certain example embodiments, the orphan drug identification data may not specify a National Drug Code (NDC), an RxNorm identifier, a Systemized Nomenclature of Medicine (SNOMED) identifier, or other identifier that exists for an orphan drug. An NDC is a unique product identifier used to identity drugs intended for human use. More specifically, an NDC is a 10-digit, 3-segment numeric identifier assigned to each medication listed under Section 510 of the FFDCA. The first segment—the labeler code—is 4 or 5 digits long and identifies a particular labeler or vendor. A labeler is any firm that manufactures, repackages, or distributes a drug product. The second segment—the product code—is 3 or 4 digits long and identifies a specific strength, dosage form, and formulation for a drug corresponding to the labeler identified by the labeler code. The third segment—the package code—is 1 or 2 digits long and identifies package forms and sizes. An NDC may exist in any of the following segment groupings: 4-4-2, 5-3-2, or 5-4-1.

An RxNorm identifier may be used as an alternative to an NDC to identify a particular drug. An RxNorm identifier may similarly include multiple segments such as, for example, a first segment indicative of an ingredient of a drug, a second segment indicative of a strength of the drug, and a third segment indicative of a dose form. Because NDCs characterize and differentiate drugs on the basis of manufacturer and package size, two different NDCs could correspond to a single RxNorm identifier. For example, a generic drug could be made by different manufacturers or provided in different package sizes. A SNOMED identifier is yet another alternative for identifying a drug that is based on the SNOMED classification system. It should be appreciated that any discussion referencing an NDC hereinafter may, in certain example embodiments, also apply to an RxNorm identifier, a SNOMED identifier, or the like.

Because an NDC may be used by different systems (e.g., a pharmacy system, a covered entity system, etc.) to identify a drug, knowledge of the NDC for an orphan drug may be needed to determine that a particular patient encounter data record and/or dispensing data record corresponds to a particular drug identified in the orphan drug identification data. If an NDC is not provided for an orphan drug in the orphan drug identification data, a stored listing, mapping, database table, or the like may be accessed to determine one or more NDCs that correspond to the orphan drug name specified in the orphan drug data record. If an NDC for the drug is located, a determination may be made as to whether the NDC corresponds to the manufacturer identified in the orphan drug record for the drug.

Accordingly, once an NDC that corresponds to the orphan drug name is located, the first segment of the NDC may be analyzed to determine if the first segment corresponds to the manufacturer identified in the orphan drug data record for that orphan drug. For example, a stored listing, mapping, database table, or the like that indicates correspondences between NDC first segments and manufacturer (labeler) names may be accessed to determine whether the first segment of the located NDC matches a stored first segment that corresponds to the manufacturer identified in the orphan drug data record. If a match is detected, the orphan drug data record for the orphan drug may be updated to include the NDC. If no match is detected, a determination may be made as to whether the orphan drug has been acquired by a different drug manufacturer. More specifically, a determination may be made as to whether an NDC exists that includes the same second and third segment codes as the located NDC but a different first segment code. If such an NDC is determined to exist, the orphan drug data record may be updated to include the NDC.

Once the processing described above is performed, a disease condition description may be identified from the orphan drug data record, and a diagnosis code corresponding to the disease condition description may be identified. The orphan drug data record may then be updated to include the diagnosis code. Diagnosis coding refers to the translation of written descriptions of diseases, illnesses, and injuries into codes from a particular classification system. Any suitable classification system may be used such as, for example, the International Statistical Classification of Diseases and Related Health Problems (ICD) Ninth Revision (ICD-9); the ICD-9, Clinical Modification (ICD-9-M); the ICD, Tenth Revision (ICD-10); the ICD-10, Clinical Modification (ICD-10-CM); and so forth.

The processing described above may be performed with respect to each orphan drug data record in the orphan drug identification data that does not include an NDC for the corresponding orphan drug to which that orphan drug data record relates. It should be appreciated that the processing described above is merely illustrative and not exhaustive. For example, similar processing may be performed to identify an RxNorm identifier, SNOMED identifier, or the like for an orphan drug. It should further be appreciated that, in certain example embodiments, an NDC for the orphan drug may not be located (e.g., neither an NDC corresponding to the manufacturer of the drug indicated in a corresponding orphan drug data record nor an NDC corresponding to a different drug manufacturer may be located), in which case, the orphan drug data record may not be updated to include an NDC.

Once the orphan drug identification data has been updated to include one or more NDCs for a corresponding one or more orphan drugs, the updated orphan drug identification data may be used in conjunction with patient encounter data and/or dispensing data to determine whether a drug dispensing event is a dispensing of an orphan drug for a designated condition, a non-orphan drug dispensing, or a dispensing of an orphan drug for a condition other than the designated condition, and to further determine whether a non-orphan drug dispensing or a dispensing of an orphan drug for a condition other than the designated condition is eligible for replenishment at a 340B price.

More specifically, in an example embodiment of the disclosure, the orphan drug 340B eligibility determination server(s) may receive patient encounter data and dispensing data. The patient encounter data may be received as part of a first data feed from a covered entity system corresponding to a covered entity. Similarly, the dispensing data may be received from a pharmacy system corresponding to one or more pharmacy locations. It should be appreciated that the patient encounter data and the dispensing data may be received from multiple covered entity systems and multiple pharmacy systems, respectively, via multiple data feeds. It should further be appreciated that a covered entity may also itself operate a pharmacy location, in which case, the patient encounter data for the covered entity and the dispensing data for the pharmacy location operated by the covered entity may be received via separate data feeds or a combined data feed.

Upon receipt, the patient encounter data and the dispensing data may be stored in one or more datastores. The orphan drug 340B eligibility determination server(s) may then execute processing to determine, for each dispensing data record included in the dispensing data, whether the dispensed drug is an orphan drug used to treat a designated condition. If it is determined that the dispensed drug was not an orphan drug or was an orphan drug used to treat a condition other than the designated condition, further processing may be executed to determine whether other criteria are met for replenishing the dispensed drug at the 340B price.

In an example embodiment of the disclosure, a particular dispensing data record may be retrieved from the stored dispensing data. It should be appreciated that while example embodiments of the disclosure may be described in connection with processing performed with respect to stored patient encounter data and/or stored dispensing data, the processing to determine 340B eligibility for orphan drug dispenses and/or non-orphan drug dispenses may occur in real-time or near real-time as the patient encounter data and/or dispensing data are received via corresponding data feeds.

Upon retrieval of a dispensing data record, a determination may be made as to whether an NDC (or other suitable identifier) identified in the dispensing data record matches an NDC (or other suitable identifier) in an orphan drug data record from the orphan drug identification data. If a match is not detected, the dispensed drug may be determined to be a non-orphan drug, and other criteria may be evaluated to determine whether the drug is eligible for replenishment at a 340B price or another reduced price such as a GPO price. The other criteria may include, for example, whether a patient identified in the dispensing data record is an outpatient, whether the prescribing entity is or is employed by a covered entity, and so forth. If, on the other hand, a match is detected, a determination may be made as to whether a dispensing date specified in the dispensing data record precedes an effective date for the orphan drug. The effective date may be a date on which the orphan drug identification data is received and may be a same or later date than a designation date on which the orphan drug was designated for use to treat a corresponding rare condition. If the dispensing date precedes the effective date, the dispensed drug may be determined to be effectively a non-orphan drug at the time of dispensing, and the other 340B eligibility criteria discussed above may be evaluated to determine whether the drug is eligible for replenishment at the 340B price. It should be appreciated that in certain example embodiments, the orphan drug's designation date may be evaluated (instead of the effective date) with respect to the dispensing date. The designation date for the orphan drug may be specified in the orphan drug data record.

If, on the other hand, the dispensing date does not precede the effective date, a set of one or more patient encounter data records may be retrieved from the stored patient encounter data. The set of retrieved patient encounter data record(s) may include the same patient medical record identifier as a patient medical record identifier included in the dispensing data record. A patient medical record identifier may be, for example, a Medical Record Number (MRN) having a structure/form defined by the Health Level-7 (HL7) set of international standards for the transfer of clinical and administrative data between hospital information systems. A patient may be assigned a unique patient medical record identifier when he/she visits a healthcare facility (e.g., a hospital) for the first time. In certain example embodiments, if a patient visits multiple healthcare facilities (e.g., multiple covered entities) within a same network, the patient may be assigned a respective unique patient medical record identifier for each facility. Thus, multiple patient medical record identifiers may be linked to a same patient.

In certain example embodiments, a single unique identifier may be used to identify a patient across multiple healthcare facilities and within multiple healthcare data systems utilized by such facilities. Such an identifier may be, for example, an HL7 master patient index. This identifier may be linked to patient identifying data stored on one or more healthcare systems and may be used to ensure accurate patient identification even in those situations in which updates to patient identifying data stored on one system are not propagated to another system. The patient identifying data may include, for example, a patient name (e.g., first name and/or last name), gender, date of birth, race/ethnicity, social security number, address information, insurance information, current diagnoses, most recent date of hospital admission and discharge, and so forth.

As previously described, a single patient identifier (e.g., a master patient index) may be used to identify a patient and may be linked to multiple patient medical record identifiers. Each patient medical record identifier may be linked to one or more account numbers, where each account number identifies a particular course of treatment or episode of care. Each account identifier may, in turn, be linked to one or more visit identifiers, where each visit identifier may identify a single visit or encounter during the corresponding course of treatment or episode of care. It should be appreciated that first data may be linked to second data using any suitable mechanism such as, for example, pointers, linked database tables having one or more common fields, etc.

Referring again to the processing described above, once the set of patient encounter data record(s) is identified, the orphan drug 340B eligibility determination server(s) may then make a determination as to whether at least one patient encounter data record of the set of patient encounter data record(s) includes a patient encounter date that is within a preceding n days/months of a current date or a preceding n days/months of the dispensing date. For example, the orphan drug 340B eligibility determination server(s) may determine if a patient encounter data record includes a patient encounter date that is within a 12 month, 6 month, 30 day, etc. period immediately preceding a dispensing date identified in the dispensing data record or a current date. This period may be configurable by a covered entity. If a patient encounter data record includes a patient encounter date that satisfies the above criteria, a further determination may be made as to whether the patient encounter data record includes a diagnosis code that corresponds to a condition specified in the orphan drug data record. If this criterion is met as well, a dispensing status identifier (e.g., a code, flag, etc.) may be stored that indicates that the dispensing data record corresponds to a dispensing of an orphan drug for a designated condition. The stored identifier may thus indicate that the dispensed drug for the dispensing data record being evaluated is not eligible for replenishment at a 340B price.

If the set of patient encounter data records does not include at least one patient encounter data record that includes a patient encounter date within the preceding n days/months and a diagnosis code corresponding to the designated condition specified in the matching orphan drug data record, a determination may be made as to whether a visit identifier is specified in the dispensing data record. If a visit identifier is not specified, a particular patient encounter data record that includes the patient medical record identifier and a patient encounter date that is within x days of the dispensing date specified in the dispensing data record may be identified. The value x may be any suitable value and may be selected based on an assumption that a prescribed drug is likely to be dispensed within x days of the date of a patient encounter during which the drug was prescribed. If, on the other hand, a visit identifier is specified in the dispensing data record, a particular patient encounter data record that includes the patient medical record identifier and a same visit identifier as specified in the dispensing data record may be identified.

Once a particular patient encounter data record is identified based on either of the processes described above, a diagnosis code specified in the particular patient encounter data record may be identified. The diagnosis code may be evaluated against a stored listing, mapping, database table, or the like to determine a description of a condition identified by the diagnosis code. The matching condition may be compared against the designated condition description specified in the matching orphan drug data record to determine that the matching condition is different from the designated condition. Alternatively, the diagnosis code specified in the particular patient encounter data record may be compared against a diagnosis code specified in the matching orphan drug data record to determine that the two codes do not match. An identifier may then be stored that indicates that the dispensing data record corresponds to a dispensing of an orphan drug for a non-designated condition, and the other criteria mentioned above may be evaluated to determine whether the drug is eligible for replenishment at a 340B price or another reduced price such as a GPO price.

Example embodiments disclosed herein provide a number of technical features or technical effects including, without limitation, automated processing to determine which orphan drug dispenses correspond to use of the orphan drug for treatment of a non-designated condition, and thus, automated processing to determine which orphan drug dispenses may be eligible for replenishment at a 340B price. It should be appreciated that the above examples of technical features of technical effects provided by example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative System Architecture

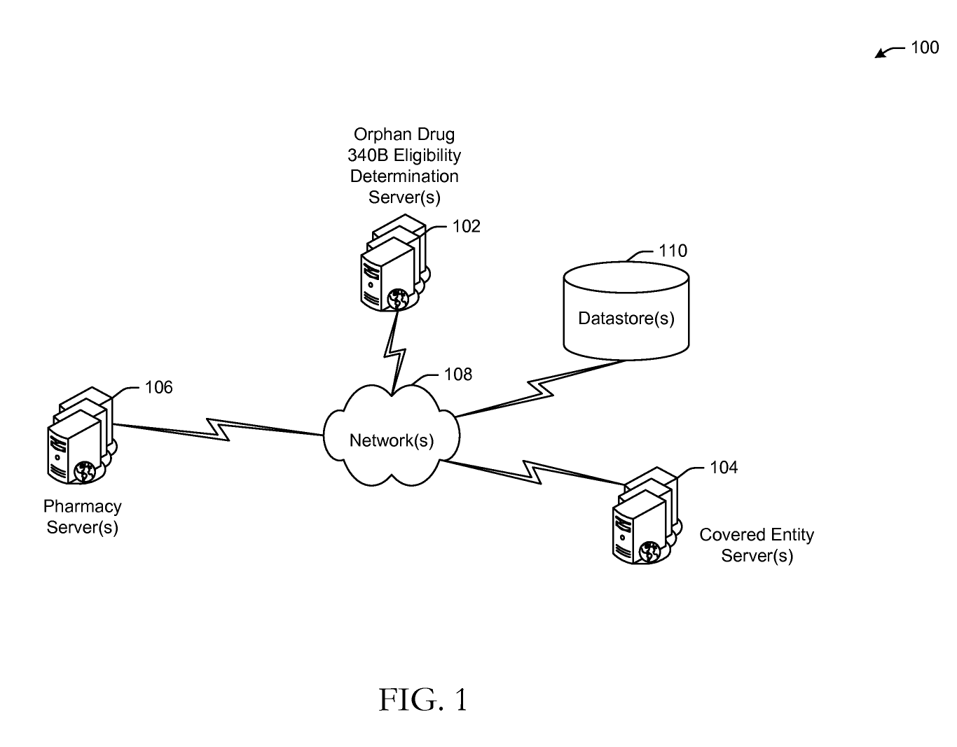

FIG. 1 is a schematic depiction of an illustrative system architecture 100 in accordance with one or more example embodiments of the disclosure. The system architecture 100 may include one or more orphan drug 340B eligibility determination servers 102, one or more covered entity servers 104, and one or more pharmacy servers 106. The architecture 100 may further include one or more datastore(s) 110 that may store orphan drug identification data, patient encounter data, dispensing data, and/or data indicative of the results of 340B eligibility determination processing performed by the orphan drug 340B eligibility determination server(s) 102. At least the orphan drug 340B eligibility determination server(s) 102, and optionally, the datastore(s) 110 and/or any other illustrative components of the architecture 100 may form part of a service provider system. While any of the illustrative components of the system architecture 100 may at times be referred to herein in the singular, it should be appreciated that multiple ones of any of the components may be provided.

Any of the illustrative components of the architecture 100 may be configured to communicate with one or more other components of the architecture 100 via one or more networks 108. The network(s) 108 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 108 may have any suitable communication range associated therewith and may include, for example, global networks (e.g., the Internet), metropolitan area networks (MANs), wide area networks (WANs), local area networks (LANs), or personal area networks (PANs). In addition, the network(s) 108 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

The network(s) 108 may allow for real-time, off-line, and/or batch transactions to be transmitted between any of the illustrative components of the architecture 100. In one or more example embodiments, the illustrative system architecture 100 may be implemented in the context of a distributed computing environment. Further, it should be appreciated that the illustrative system architecture 100 may be implemented in accordance with any suitable network configuration. For example, the network(s) 108 may include a plurality of networks, each with devices such as gateways, routers, linked-layer switches, and so forth for providing connectivity between or among the various devices forming part of the system architecture 100. In some example embodiments, dedicated communication links may be used to connect the various devices of the architecture 100.

The covered entity server(s) 104 may operate on behalf of one or more covered entities and may be provided locally or remotely from one or more covered entity locations. One or more data feeds containing patient encounter data may be received from the covered entity server(s) 104. The pharmacy server(s) 106 may operate on behalf of one or more pharmacies or and may be provided locally or remotely from one or more pharmacy locations. One or more data feeds containing the dispensing data may be received from the pharmacy server(s) 106. The dispensing data may include healthcare claim transaction data received in real-time or near-real-time and formatted in accordance with an National Council for Prescription Drug Programs (NCPDP) standard, batch data, or the like. In certain example embodiments, such as those in which a covered entity also operates a pharmacy, corresponding patient encounter data and dispensing data for the covered entity and the pharmacy, respectively, may be received from a same set of one or more servers. In certain example embodiments, the orphan drug identification data may be received from one or more other servers (not shown).

One or more of the orphan drug 340B eligibility determination server 102, the covered entity server 104, and/or the pharmacy server 106 may include one or more processing units that may be configured to access and read computer-readable media having stored thereon data and/or computer-executable instructions for implementing various functionality described herein. Further, any of the illustrative components of the architecture 100 may include or otherwise be associated with suitable hardware, firmware, and/or software components for receiving, processing, and/or transmitting data and/or computer-executable instructions over one or more communications links or networks. These networked devices and systems may also include any number of processors for processing data and executing computer-executable instructions, as well as other internal and peripheral components. Further, these networked devices and systems may include or be in communication with any number of suitable memory devices operable to store data and/or computer-executable instructions. By storing and/or executing computer-executable instructions, each of the networked devices may form a special purpose computer or a particular machine.

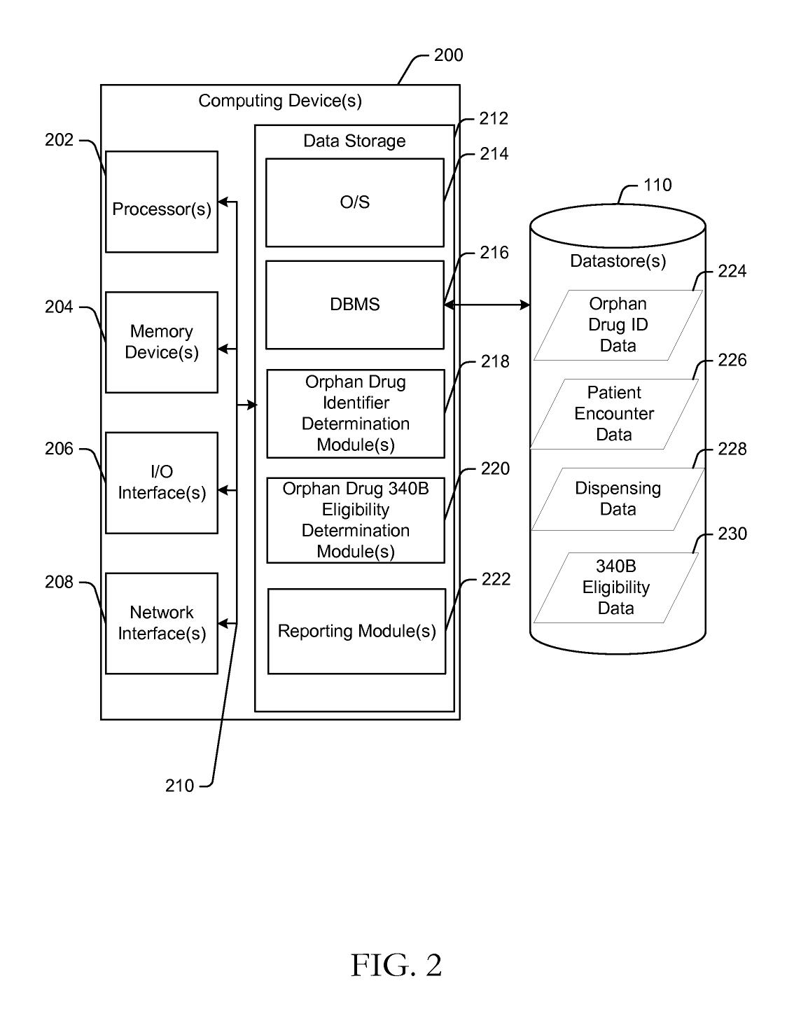

FIG. 2 depicts example hardware and software components of an illustrative computing device 200 in accordance with one or more example embodiments of the disclosure. In certain example embodiments, the computing device 200 may correspond to an illustrative configuration of an orphan drug 340B eligibility determination server 102. It should be appreciated that the computing device 200 may actually represent multiple computing devices that operate in accordance with a distributed computing model. For example, certain program modules depicted and described as part of the illustrative configuration of the computing device 200 depicted in FIG. 2 may actually reside on and may be executed on different orphan drug 340B eligibility determination servers 102. In addition, any given program module may be partitioned across multiple orphan drug 340B eligibility determination servers 102.

In an illustrative configuration, the computing device 200 may include one or more processors (processor(s)) 202, one or more memory devices 204 (generically referred to herein as memory 204), one or more input/output (“I/O”) interface(s) 206, one or more network interfaces 208, and data storage 212. The device 200 may further include one or more buses 210 that functionally couple various components of the device 200. These various components will be described in more detail hereinafter.

The bus(es) 210 may include at least one of a system bus, a memory bus, an address bus, or a message bus, and may permit exchange of information (e.g., data (including computer-executable code), signaling, etc.) between various components of the device 200. The bus(es) 210 may include, without limitation, a memory bus or a memory controller, a peripheral bus, an accelerated graphics port, and so forth. The bus(es) 210 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 204 of the device 200 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 204 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 204 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 212 may include removable storage and/or non-removable storage including, but not limited to, magnetic storage, optical disk storage, solid state storage, and/or tape storage. The data storage 212 may provide non-volatile storage of computer-executable instructions and other data. The memory 204, the data storage 212, and the datastore(s) 110, removable and/or non-removable, are examples of computer-readable storage media (CRSM) as that term is used herein.

The data storage 212 may store computer-executable code, instructions, or the like that may be loadable into the memory 204 and executable by the processor(s) 202 to cause the processor(s) 202 to perform or initiate various operations. The data storage 212 may additionally store data that may be copied to memory 204 for use by the processor(s) 202 during the execution of the computer-executable instructions. Moreover, output data generated as a result of execution of the computer-executable instructions by the processor(s) 202 may be stored initially in memory 204, and may ultimately be copied to data storage 212 and/or the datastore(s) 110 for non-volatile storage.

More specifically, the data storage 212 may store one or more operating systems (O/S) 214; one or more database management systems (DBMS) 216; and one or more program modules, applications, or the like such as, for example, one or more orphan drug identifier determination modules 218, one or more orphan drug 340B eligibility determination modules 220, and one or more reporting modules 228. Any of the program modules may include one or more sub-modules. Any of the modules depicted in FIG. 2 may include computer-executable code, instructions, or the like that may be loaded into the memory 204 for execution by one or more of the processor(s) 202. Further, any data (e.g., data stored in one or more of the datastore(s) 110) may be loaded into the memory 204 for use by the processor(s) 202 in executing computer-executable code.

The processor(s) 202 may be configured to access the memory 204 and execute computer-executable instructions loaded therein. For example, the processor(s) 202 may be configured to execute computer-executable instructions of the various program modules of the device 200 to cause or facilitate various operations to be performed in accordance with one or more embodiments of the disclosure. The processor(s) 202 may include any suitable processing unit capable of accepting data as input, processing the input data in accordance with stored computer-executable instructions, and generating output data. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 202 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 202 may be capable of supporting any of a variety of instruction sets.

Referring now to various illustrative components depicted as being stored in the data storage 212, the O/S 214 may be loaded from the data storage 212 into the memory 204 and may provide an interface between other application software executing on the device 200 and hardware resources of the device 200. More specifically, the O/S 214 may include a set of computer-executable instructions for managing hardware resources of the device 200 and for providing common services to other application programs (e.g., managing memory allocation among various application programs). The O/S 214 may include any operating system now known or which may be developed in the future including, but not limited to, any server operating system, any mainframe operating system, or any other proprietary or non-proprietary operating system.

The DBMS 216 may be loaded into the memory 204 and may support functionality for accessing, retrieving, storing, and/or manipulating data stored in the memory 204, data stored in the data storage 212, and/or data stored in the datastore(s) 110. The DBMS 216 may use any of a variety of database models (e.g., relational model, object model, etc.) and may support any of a variety of query languages. The DBMS 216 may access data represented in one or more data schemas and stored in any suitable data repository including, but not limited to, databases (e.g., relational, object-oriented, etc.), file systems, flat files, distributed datastores in which data is stored on more than one node of a computer network, peer-to-peer network datastores, or the like.

The datastore(s) 110 may store various types of data including, without limitation, orphan drug identification data 224, patient encounter data 226, dispensing data 228, and 340B eligibility data 230. The orphan drug identification data 224 may include, for example, a listing of orphan drugs and corresponding identifying information for each orphan drug. The identifying information may include, for example, a character string indicative of a name of the drug (a trade name and/or a chemical name); a character string indicative of a date on which the drug was designated as an orphan drug for use to treat a rare condition; a character string indicative of a name of a manufacturer of the drug; an indication of the designated condition such as, for example, a character string that provides a description of the designated condition or a diagnosis code corresponding to the condition; an indication (e.g., a Boolean flag) of whether the drug has been FDA approved; and so forth. The orphan drug identification data may be received in any suitable format such as, for example, as part of downloadable file, a data feed, or the like. The orphan drug identification data 224 may further include orphan drug data records that are updated to include NDCs or other identifiers for corresponding orphan drugs.

The patient encounter data 226 may include patient encounter data records that correspond to various patient encounters (e.g., clinic visits, hospital visits, etc.). For example, each patient encounter data record may correspond to a particular patient interaction with a healthcare provider at a healthcare facility and may include, without limitation, a patient identifier (e.g., a master patient index) and/or other patient identifying information (e.g., name, social security number, address information, health insurance claim number (HICN), etc.), a patient medical record identifier (e.g., a Medical Record Number), a visit identifier, a diagnosis code, a prescribing entity identifier (e.g., a National Provider Identifier), a patient encounter date (e.g., a date of a patient visit to a healthcare facility), and so forth. The patient encounter data 226 may be received via one or more data feeds from the covered entity server(s) 104.

The dispensing data 228 may include dispensing data records that correspond to various drug dispensing events. For example, each dispensing data record may correspond to a particular amount of a drug dispensed to a particular patient and may include, without limitation, a patient identifier (e.g., a master patient index) and/or other patient identifying information (e.g., name, social security number, address information, HICN, etc.), an NDC or other identifier (e.g., RxNorm identifier) for the dispensed drug, a dispensing date, a visit identifier, and so forth. The dispensing data 228 may be received via one or more data feeds from the pharmacy server(s) 106. Any information described as being included in the dispensing data 228 may alternatively or additionally be included in the patient encounter data 226, or vice versa.

The 340B eligibility data 230 may include various types of output data generated as a result of the processing described herein. For example, the 340B eligibility data 230 may include stored dispensing status identifiers that are linked to corresponding dispensing data records and that indicate whether, for each dispensing data record, a non-orphan drug was dispensed, an orphan drug was dispensed for a non-designated condition, or an orphan drug was dispensed for the designated condition. The 340B eligibility data 230 may further indicate, for each dispensing data record, a determination as to whether a corresponding dispensing is eligible to be replenished at a 340B price.

Referring now to functionality supported by the various program modules depicted in FIG. 2, the orphan drug identifier determination module(s) 218 may include computer-executable instructions, code, or the like that, responsive to execution by one or more of the processor(s) 202, may cause processing to be performed to identify an NDC for each orphan drug data record that does not specify an NDC. In particular, the orphan drug identifier determination module(s) 218 may include computer-executable instructions, code, or the like for identifying an NDC that corresponds to the orphan drug and drug manufacturer specified in an orphan drug data record and updating the orphan drug data record to include the identified NDC.

The orphan drug 340B eligibility determination module(s) 220 may include computer-executable instructions, code, or the like that, responsive to execution by one or more of the processor(s) 202, may cause processing to be performed to determine, for each dispensing data record, whether the corresponding drug that is dispensed is an orphan drug, and if so, whether the orphan drug was dispensed in connection with a designated condition. If the processing performed by the orphan drug 340B eligibility determination module(s) 220 reveals that a non-orphan drug was dispensed or that an orphan drug was dispensed for a non-designated condition, the orphan drug 340B eligibility determination module(s) 220 may further include computer-executable instructions, code, or the like for determining whether other criteria are met for making the dispensed drug eligible for replenishment at the 340B price.

The reporting module(s) 222 may include computer-executable instructions, code, or the like that, responsive to execution by one or more of the processor(s) 202, may cause processing to be performed to generate one or more reports indicative of 340B eligibility determinations made responsive to execution of computer-executable instructions of the orphan drug 340B eligibility determination module(s) 220. The report(s) may be communicated to the pharmacy server(s) 106 and/or the covered entity server(s) 104.

Referring now to other illustrative components of the device 200, one or more input/output (I/O) interfaces 206 may be provided that may facilitate the receipt of input information by the device 200 from one or more I/O devices as well as the output of information from the device 200 to the one or more I/O devices. The I/O devices may include, for example, one or more user interface devices that facilitate interaction between a user and the device 200 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The device 200 may further include one or more network interfaces 208 via which the device 200 may communicate with any of a variety of other systems, platforms, networks, devices, and so forth. Such communication may occur via any one or more of the network(s) 108.

It should be appreciated that the program modules, applications, computer-executable instructions, code, or the like depicted in FIG. 2 as being stored in the data storage 212 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the device 200, and/or hosted on other computing device(s) accessible via one or more networks, may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

It should further be appreciated that the device 200 may include alternate and/or additional hardware, software, or firmware components beyond those described or depicted without departing from the scope of the disclosure. More particularly, it should be appreciated that software, firmware, or hardware components depicted as forming part of the device 200 are merely illustrative and that some components may not be present or additional components may be provided in various embodiments. While various illustrative program modules have been depicted and described as software modules stored in data storage 212, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

### Illustrative Processes

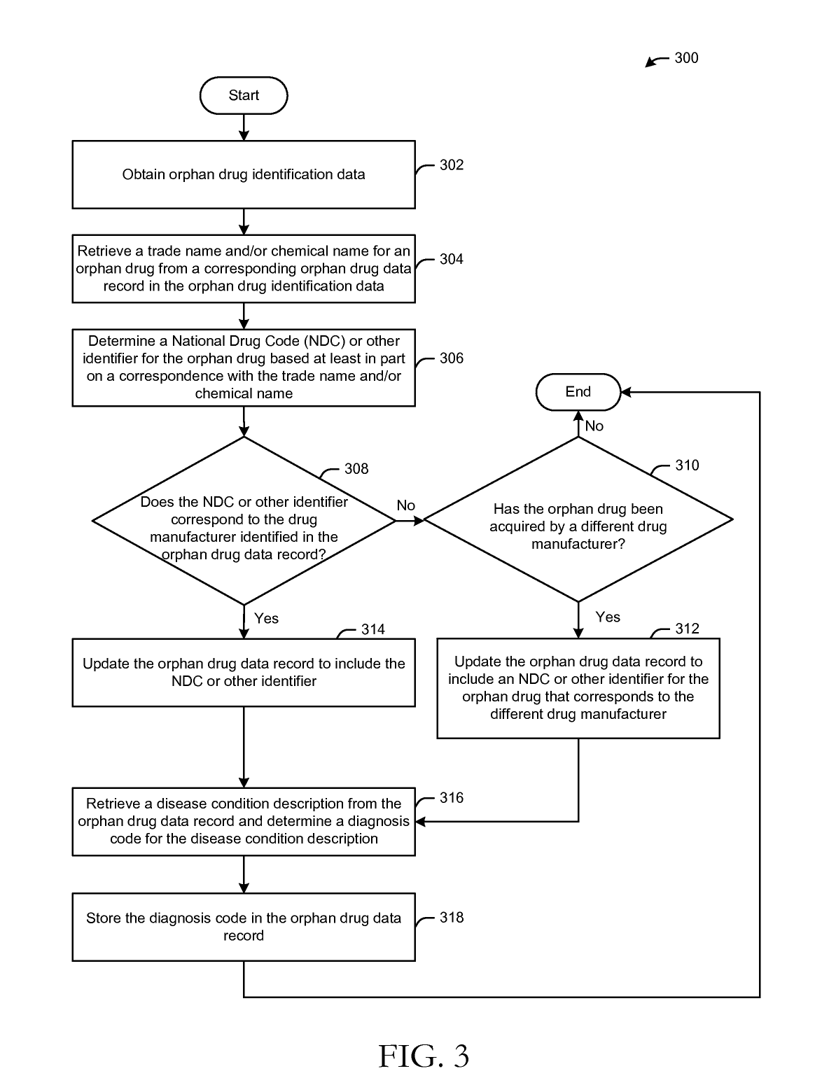

FIG. 3 is a process flow diagram of an illustrative method 300 for updating an orphan drug data record for an orphan drug in accordance with one or more example embodiments of the disclosure. In certain example embodiments, one or more of the operations of method 300 may be performed responsive to execution of computer-executable instructions, code, or the like of the orphan drug identifier determination module(s) 218.

At block 302, the orphan drug 340B eligibility determination server(s) 102 may obtain orphan drug identification data 224. More specifically, the orphan drug 340B eligibility determination server(s) 102 may receive orphan drug identification data 224 from an external source (e.g., a governmental or non-governmental third party) and may store the orphan drug identification data 224 in the datastore(s) 110. As previously described, the orphan drug identification data 224 may include, for example, a listing of orphan drugs and corresponding identifying information for each orphan drug. The identifying information may include, for example, a name of the drug (a trade name and/or a chemical name); a date on which the drug was designated as an orphan drug for use to treat a rare condition; a name of a manufacturer of the drug; an indication of the designated condition; an indication of whether the drug has been FDA approved for treating the designated condition; and so forth.

In certain example embodiments, despite including a trade name and/or chemical name for an orphan drug, the orphan drug identification data 224 may not include a National Drug Code (NDC) or other identifier (e.g., RxNorm identifier, a SNOMED identifier, etc.) for the orphan drug. The processing at blocks 304-318 may be performed for those orphan drug data record(s) that do not specify an NDC or similar type of identifier. The orphan drug identifier determination module(s) 218 may determine that an orphan drug data record does not include an NDC or other similar type of identifier by checking each data field of the data record to determine if the field is populated with an identifier having the appropriate format or by checking if a designated field is populated. At block 304, the orphan drug identifier determination module(s) 218 may retrieve a character string indicative of a trade name and/or chemical name for an orphan drug an orphan drug data record that does not specify an NDC.

At block 306, the orphan drug identifier determination module(s) 218 may determine an NDC for the orphan drug based at least in part on a correspondence with the retrieved trade name and/or chemical name. More specifically, the module(s) 218 may access a stored listing, mapping, database table, or the like to determine if the retrieved trade name and/or chemical name from the orphan drug data record matches a trade name and/or chemical name in the stored listing, mapping, database table, or the like. If the orphan drug identifier determination module(s) 218 identify a match, the module(s) 218 may further identify one or more NDCs that correspond to the matching trade name and/or chemical name in the stored listing, mapping, database table, or the like. Processing of method 300 subsequent to block 306 assumes that one or more NDCs or other drug identifiers have been identified at block 306.

At block 308, the orphan drug identifier determination module(s) 218 may determine, with respect to each NDC identified at block 306, whether the NDC corresponds to the manufacturer identified in the orphan drug record for the drug. More specifically, the first segment of the NDC may be analyzed to determine if it corresponds to the manufacturer identified in the orphan drug data record for that orphan drug. For example, a stored listing, mapping, database table, or the like that indicates correspondences between NDC first segments and manufacturer (labeler) names may be accessed to determine whether the first segment of the located NDC matches a stored NDC first segment that corresponds to the manufacturer identified in the orphan drug data record.

If a match is detected at block 308, the orphan drug data record for the orphan drug may be updated to include the NDC at block 314. If no match is detected at block 308, the orphan drug identifier determination module(s) 218 may determine, at block 310, whether the orphan drug has been acquired by a different drug manufacturer. More specifically, the determination at block 310 may involve a determination as to whether an NDC exists that includes the same second and third segment codes as an NDC identified at block 306 but a different first segment code. More specifically, the orphan drug identifier determination module(s) 218 may access a stored listing, mapping, database table, or the like that indicates NDCs that correspond to the trade name and/or chemical name specified in the orphan drug data record. Multiple NDCs may correspond to the same trade name and/or chemical name with each NDC being indicative of a different manufacturer, drug strength, and/or dosage form. The orphan drug identifier determination module(s) 218 may parse the NDCs corresponding to the trade name and/or chemical name specified in the orphan drug data record to determine if any of the NDCs include the same second and third segments as the NDC identified at block 306 but a different first segment. If such an NDC is determined to exist, the orphan drug data record may be updated to include the NDC at block 312.

From either block 312 or block 314, the method 300 may proceed to block 316 where the orphan drug identifier determination module(s) 218 may retrieve a character string indicative of a disease condition description from the orphan drug data record and identify a diagnosis code corresponding to the disease condition description. In particular, the orphan drug identifier determination module(s) 218 may access a stored listing, mapping, database table, or the like to locate a character string that matches the character string retrieved from the orphan drug data record. A diagnosis code linked to the matching character string in the stored listing, mapping, database table, or the like may then be identified. The orphan drug identifier determination module(s) 218 may then update the orphan drug data record stored in the datastore(s) 110 to include the diagnosis code at block 318.

The processing of method 300 may be performed with respect to each orphan drug data record in the orphan drug identification data 224 that does not include an NDC for the corresponding orphan drug to which that orphan drug data record relates. It should be appreciated that the processing described above is merely illustrative and not exhaustive. For example, the processing may be performed to identify an RxNorm identifier, a SNOMED identifier, or any other suitable drug identifier for an orphan drug. It should further be appreciated that, in certain example embodiments, an NDC for the orphan drug may not be located (e.g., neither an NDC corresponding to the manufacturer of the drug indicated in a corresponding orphan drug data record nor an NDC corresponding to a different drug manufacturer may be located), in which case, the orphan drug data record may not be updated to include an NDC (e.g., a NO determination at block 310).

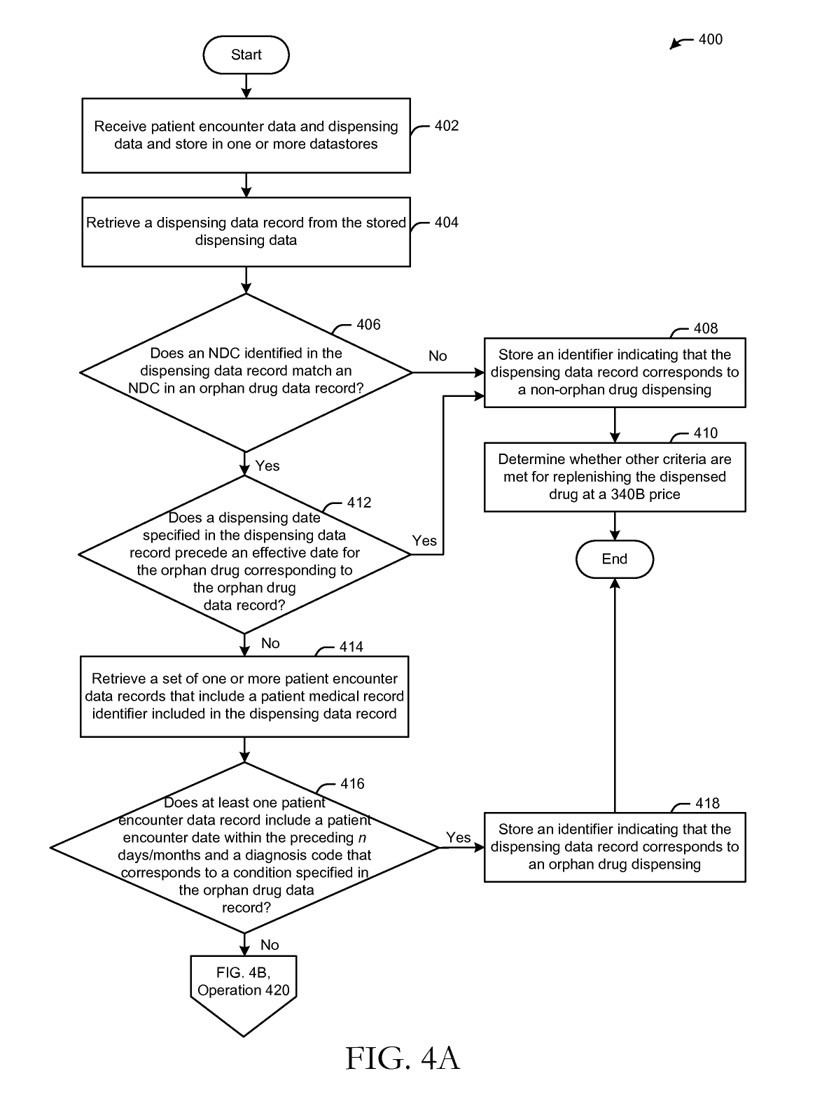

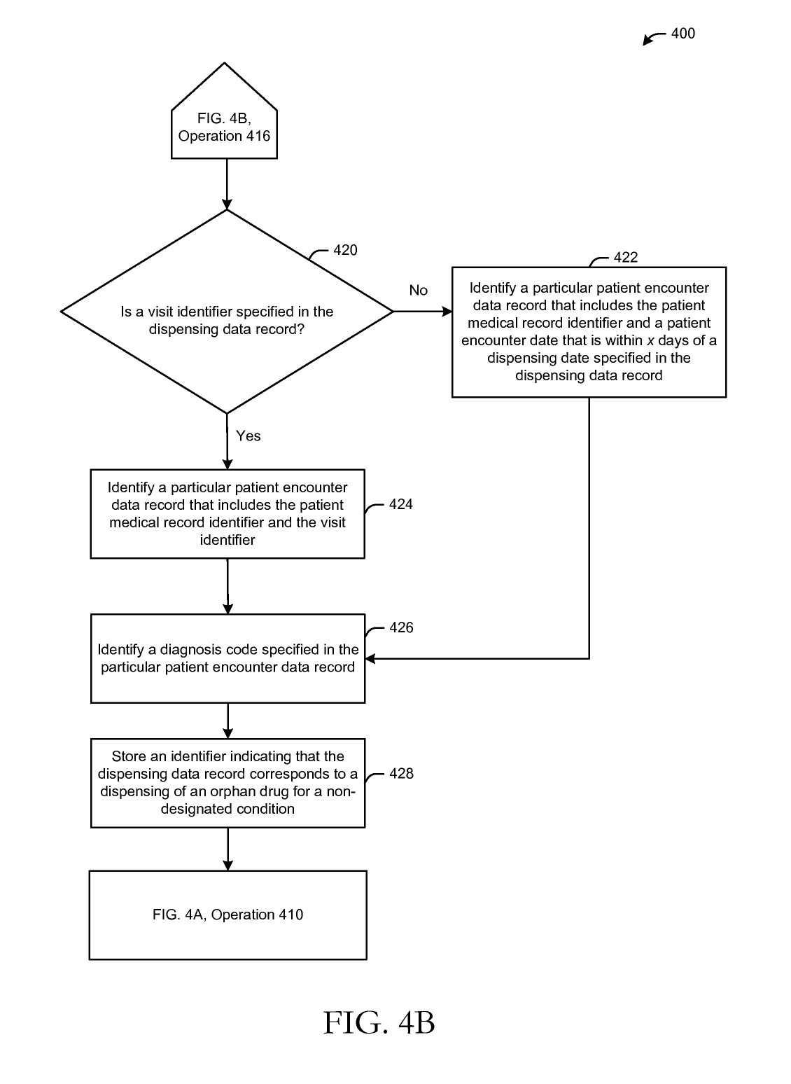

FIGS. 4A-4B are process flow diagrams of an illustrative method 400 for determining whether an orphan drug is eligible for replenishment at a reduced price in accordance with one or more example embodiments of the disclosure. One or more operations of the method 400 may be performed responsive to execution of computer-executable instructions, code, or the like of the orphan drug 340B eligibility determination module(s) 220.

Referring first to FIG. 4A, at block 402, the orphan drug 340B eligibility determination server(s) 102 may receive patient encounter data 226 and dispensing data 228. The patient encounter data 226 may be received as part of one or more data feeds from the covered entity server(s) 104. Similarly, the dispensing data 228 may be received as part of one or more data feeds from the pharmacy server(s) 102. Upon receipt, the patient encounter data 226 and the dispensing data 228 may be stored in the datastore(s) 110.

The orphan drug 340B eligibility determination server(s) 102 may then execute processing to determine, for each dispensing data record included in the dispensing data 228, whether the dispensed drug is an orphan drug used to treat a designated condition. If it is determined that the dispensed drug was not an orphan drug or was an orphan drug used to treat a condition other than the designated condition, further processing may be executed to determine whether other criteria are met for replenishing the dispensed drug at the 340B price. The processing of method 400 after block 402 corresponds to a particular dispensing data record. However, it should be appreciated that similar processing may be performed with respect to each dispensing data record in the dispensing data 228.

At block 404, a particular dispensing data record may be retrieved from the stored dispensing data 228. Upon retrieval of the dispensing data record, the orphan drug 340B eligibility determination module(s) 220 may compare, at block 406, an NDC specified in the dispensing data record to a respective NDC in each of one or more orphan drug data records to determine whether an orphan drug data record exists in the orphan drug identification data 224 that includes an NDC that matches the NDC specified in the dispensing data record. If a match is not detected at block 406, the method 400 may proceed to block 408, where the orphan drug 340B eligibility determination module(s) 220 may generate a dispensing status identifier indicating that a dispensing event to which the dispensing data record corresponds is a non-orphan drug dispensing. The orphan drug 340B eligibility determination module(s) 220 may further store the dispensing status identifier at block 408 and link the dispensing status identifier to the dispensing data record such that querying the datastore(s) 110 for the dispensing data record may return the dispensing status identifier.

Then, at block 410, the orphan drug 340B eligibility determination module(s) 220 may evaluate other criteria to determine whether the drug is eligible for replenishment at a 340B price or another reduced price such as a GPO price. The other criteria may include, for example, whether a patient identified in the dispensing data record is an outpatient, whether the prescribing entity is or is employed by a covered entity, and so forth. More specifically, the orphan drug 340B eligibility determination module(s) 220 may locate a patient status code or the like in the dispensing data record or a patient encounter data record that includes a same patient medical record identifier and/or visit identifier as the dispensing data record, and may access a stored listing, mapping, database table, or the like that indicates correspondences between various patient codes and patient statuses to determine if the retrieved patient status code matches a stored patient code that corresponds to an outpatient status. Similarly, a the orphan drug 340B eligibility determination module(s) 220 may locate a prescribing entity identifier or the like in the dispensing data record or a patient encounter data record that includes a same patient medical record identifier and/or visit identifier as the dispensing data record, and may access a stored listing, mapping, database table, or the like that includes various prescribing entity identifiers and an indication of either covered entity status or non-covered entity status for each prescribing entity identifier to determine if the retrieved prescribing entity identifier matches a stored prescribing entity identifier having a covered entity status. If the various 340B eligibility criteria are met, the dispensing event to which the dispensing data record relates may be determined to be eligible for replenishment at the 340B price. If the 340B eligibility criteria are not met, the orphan drug 340B eligibility determination module(s) 220 may determine that the dispensing is instead eligible for a higher price, such as a GPO price, which may nonetheless be lower than a WAC price.

If, on the other hand, a match is detected at block 406, the orphan drug 340B eligibility determination module(s) 220 may determine, at block 412, whether a dispensing date specified in the dispensing data record precedes an effective date for the orphan drug data record. The effective date may be a date on which the orphan drug identification data 224 is received and may be later date than a designation date specified in the orphan drug data record. More specifically, the orphan drug 340B eligibility determination module(s) 220 may retrieve a dispensing date from the dispensing data record and compare the dispensing date to the effective date to determine whether the dispensing date precedes the effective date. If the dispensing date precedes the effective date, the orphan drug 340B eligibility determination module(s) 220 may determine that the dispensed drug was effectively a non-orphan drug at the time of dispensing, and the method may proceed to block 408 where the orphan drug 340B eligibility determination module(s) 220 may generate a dispensing status identifier indicating that the dispensing data record corresponds to a non-orphan drug dispensing and may store and link the dispensing status identifier to the dispensing data record. Then, at block 410, the orphan drug 340B eligibility determination module(s) 220 may evaluate other criteria to determine whether the drug is eligible for replenishment at a 340B price or another reduced price such as a GPO price as described previously.

If, on the other hand, the dispensing date does not precede the effective date, the orphan drug 340B eligibility determination module(s) 220 may retrieve a set of one or more patient encounter data records from the stored patient encounter data 226 at block 414. The set of retrieved patient encounter data record(s) may include a same patient medical record identifier as a patient medical record identifier included in the dispensing data record. In certain example embodiments, only matching patient encounter data records within a specified date range may be retrieved. The orphan drug 340B eligibility determination module(s) 220 may then determine, at block 416, whether at least one patient encounter data record of the set of patient encounter data record(s) includes a patient encounter date that is within a preceding n days/months of a current date or a preceding n days/months of the dispensing date specified in the dispensing data record. This period may be configurable by a covered entity to which the dispensing data record relates. More specifically, the orphan drug 340B eligibility determination module(s) 220 may retrieve a respective patient encounter date from each patient encounter data record in the set of patient encounter data record(s), may determine a number of days/months between the retrieved patient encounter date and the current date or the dispensing date, and may compare this determined number of days/months to the configurable threshold. If a patient encounter data record includes a patient encounter date that satisfies the above criteria and further includes a diagnosis code that corresponds to a condition specified in the orphan drug data record, the orphan drug 340B eligibility determination module(s) 220 may generate a dispensing status identifier (e.g., a code, flag, etc.) that indicates that the dispensing data record corresponds to a dispensing of an orphan drug for a designated condition and may store and link the dispensing status identifier to the dispensing data record at block 418. The stored identifier may thus indicate that the dispensed drug for the dispensing data record being evaluated is not eligible for replenishment at a 340B price. In addition to the determination at block 416, the orphan drug 340B eligibility determination module(s) 220 may determine whether a patient age specified in the dispensing data record or any of the patient encounter data record(s) falls within an age range specified in the matching orphan drug data record. If so, the operation at block 418 may be performed. If not, the method may proceed to block 420.

Referring now to FIG. 4B, if, on the other hand, the set of patient encounter data records does not include at least one patient encounter data record that includes a patient encounter date within the preceding n days/months and a diagnosis code corresponding to the designated condition specified in the matching orphan drug data record, the orphan drug 340B eligibility determination module(s) 220 may determine, at block 420, whether a visit identifier is specified in the dispensing data record. If a visit identifier is not specified, a particular patient encounter data record that includes the patient medical record identifier and a patient encounter date that is within x days of the dispensing date specified in the dispensing data record may be identified at block 422. The value x may be any suitable value and may be selected based on an assumption that a prescribed drug is likely to be dispensed within x days of the date of a patient encounter. In certain example embodiments, the value of x may be less than the value of n. If, on the other hand, a visit identifier is specified in the dispensing data record, the orphan drug 340B eligibility determination module(s) 220 may identify, at block 424, a particular patient encounter data record that includes the patient medical record identifier and a same visit identifier as specified in the dispensing data record.

Once a particular patient encounter data record is identified at either block 422 or block 424, the orphan drug 340B eligibility determination module(s) 220 may identify a diagnosis code specified in the particular patient encounter data record at block 426. In certain example embodiments, the orphan drug 340B eligibility determination module(s) 220 may first confirm that the patient encounter date specified in the patient encounter data record is within the configurable timeframe from the dispensing date with respect to block 416. If this is the case, the diagnosis code necessarily corresponds to a condition that is different from the designated condition specified in the matching orphan drug data record, and the orphan drug 340B eligibility determination module(s) 220 may generate a dispensing status identifier that indicates that the dispensing data record corresponds to a dispensing of an orphan drug for a non-designated condition and may store and link the dispensing status identifier to the dispensing data record at block 428. The method may proceed to block 410 where the orphan drug 340B eligibility determination module(s) 220 may evaluate the 340B eligibility criteria mentioned above to determine whether the drug is eligible for replenishment at a 340B price or another reduced price such as a GPO price. If, on the other hand, the orphan drug 340B eligibility determination module(s) 220 determine that the patient encounter date specified in the patient encounter data record identified at block 424 is not within the configurable timeframe from the dispensing date, the orphan drug 340B eligibility determination module(s) 220 may retrieve the diagnosis code from the patient encounter data record and determine whether a condition identified by the diagnosis code is the designated condition for the orphan drug or an alternate condition. If the diagnosis code corresponds to a non-designated condition, the operation at block 428 may be performed, whereas if the diagnosis code corresponds to the designated condition, the operation at block 418 may be performed.

One or more operations of the method 300 or the method 400 may have been described above as being performed by one or more modules of a the computing device 200 that may, in certain example embodiments, correspond to an illustrative configuration of one or more orphan drug eligibility determination servers 102. It should be appreciated, however, that any operation of the method 300 or the method 400 described as being performed by a particular module executing on a particular device may be performed, at least in part, by another module executing on the same or a different device of the architecture 100. In addition, it should be appreciated that processing performed in response to execution of computer-executable instructions provided as part of an application, program module, or the like may be interchangeably described herein as being performed by the application or the program module itself, by a device on which the application, program module, or the like is executing, or by a system that includes such a device. While the operations of the method 300 or the method 400 may be described in the context of the illustrative system architecture 100 and the illustrative device configuration depicted in FIG. 2, it should be appreciated the method 300 or the method 400 may be implemented in connection with numerous other architectural and device level configurations.

The operations described and depicted in the illustrative methods of FIGS. 3-4B may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 3-4B may be performed.

While certain example embodiments disclosed herein have been described as involving the transmission or receipt of data between the orphan drug 340B eligibility determination server 102 and other illustrative components of the illustrative architecture 100, in certain other example embodiments, such transmissions may be internal transmissions occurring within the orphan drug 340B eligibility determination server 102 or may be omitted altogether. Further, while example embodiments described herein with reference to FIGS. 3-4B describe certain example operations as occurring at or being performed by the server 102 or certain example data transmissions as originating at or being received by the server 102, in alternative example embodiments, such example data transmissions may originate at or may be received by, or such example operations may occur at or may be performed by, the covered entity server 104, the pharmacy server 106, or a separate or distinct computer or computer system, a combination of two or more such devices, and/or a combination of one or more such devices along with the server 102. In such alternate example embodiments, certain transmission/receiving steps and/or certain data transmissions described above with reference to FIGS. 1-4B may be omitted while others may be added, as will be understood by one of ordinary skill in the art. The intent being that, in alternate example embodiments, any of the devices/computers described and depicted with respect to FIG. 1 are capable of performing any one or more operations or originating/receiving any one or more data transmissions of any of the methods described with reference to FIGS. 1-4B.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Program modules, applications, or the like disclosed herein may include one or more software components including, for example, software objects, methods, data structures, or the like. Each such software component may include computer-executable instructions that, responsive to execution, may cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A computer-implemented method, comprising:
receiving, at a service provider system comprising one or more computers, orphan drug identification data, patient encounter data, and dispensing data;
identifying, by the service provider system, a dispensing data record included in the dispensing data, wherein the dispensing data record corresponds to a particular drug dispensing event;
determining, by the service provider system, that a first product identifier included in the dispensing data record matches a second product identifier included in an orphan drug data record included in the orphan drug identification data, wherein the product identifier identifies an orphan drug designated for treatment of a designated condition;
determining, by the service provider system, that a dispensing date specified in the dispensing data record is chronologically after an effective date that the orphan drug data record was generated;
retrieving, by the service provider system, a set of one or more patient encounter data records included in the patient encounter data, wherein a respective patient medical record identifier included in each patient encounter data record matches a patient medical record identifier included in the dispensing data record;
determining, by the service provider system, for each patient encounter data record, that a respective patient encounter date specified in the patient encounter data record is more than a threshold period of time before a predetermined date or determining that a respective diagnosis code included in the patient encounter data record corresponds to a respective condition other than the designated condition;
identifying, by the service provider system, a particular patient encounter data record that includes a diagnosis code that corresponds to a condition other than the particular condition;
storing, by the service provider system, a dispensing status identifier for the dispensing data record indicating that the drug dispensing event is a dispensing of the orphan drug for a particular condition other than the designated condition; and
determining, by the service provider system, whether at least one eligibility criterion is satisfied for replenishing a quantity of the orphan drug dispensed as part of the drug dispensing event at a 340B price for the orphan drug.

2. The method of claim 1, wherein the threshold period of time is a first threshold period of time, and wherein identifying the particular patient encounter data record that includes the diagnosis code that corresponds to the particular condition comprises:
determining, by the service provider system, whether the dispensing data record includes a visit identifier; and
determining, by the service provider system, that the particular patient encounter data record includes the visit identifier if the dispensing data record includes the visit identifier or determining, by the service provider system, that a particular patient encounter date specified in the particular patient encounter data record is within a second threshold period of time of the dispensing date.

3. The method of claim 1, wherein determining whether the at least one eligibility criterion is satisfied comprises:
determining, by the service provider system, that a patient status identifier included in the dispensing data record identifies an outpatient status for a patient to whom the orphan drug was dispensed; and
determining, by the service provider system, that a prescriber identifier included in the dispensing data record identifies a covered entity.

4. The method of claim 1, wherein the predetermined date is the dispensing date or a date corresponding to receipt of the dispensing data record.

5. A computer-implemented method, comprising:
receiving, at a service provider system comprising one or more computers, orphan drug identification data, patient encounter data, and dispensing data;
identifying, by the service provider system, a dispensing data record included in the dispensing data, wherein the dispensing data record corresponds to a drug dispensing event;
identifying, by the service provider system, a first product identifier included in the dispensing data record;
determining, by the service provider system, whether the first product identifier matches a second product identifier included in an orphan drug data record included in the orphan drug identification data;
generating, by the service provider system, a dispensing status identifier indicating one of: i) a first dispensing status indicating that the drug dispensing event is a dispensing of a non-orphan drug, ii) a second dispensing status indicating that the drug dispensing event is a dispensing of an orphan drug for a particular condition other than a designated condition for which the orphan drug is designated for treatment, wherein the orphan drug data record includes a description of the designated condition, or iii) a third dispensing status indicating that the drug dispensing event is a dispensing of the orphan drug for the designated condition;
storing, by the service provider system, the status identifier in association with the dispensing data record; and
determining, by the service provider system, whether at least one eligibility criterion is satisfied for replenishing a quantity of a drug dispensed as part of the drug dispensing event at a 340B price for the drug if the dispensing status identifier indicates the first dispensing status or the second dispensing status.

6. The method of claim 5, wherein it is determined that the first product identifier does not match the second product identifier, and wherein the dispensing status identifier indicates the first dispensing status.

7. The method of claim 5, wherein it is determined that the first product identifier matches the second product identifier, the method further comprising:
determining, by the service provider system, that a dispensing date specified in the dispensing data record chronologically precedes an effective date that the orphan drug data record was generated,
wherein the dispensing status identifier indicating the first dispensing status is generated responsive to determining that the dispensing date chronologically precedes the effective date.

8. The method of claim 5, wherein it is determined that the first product identifier matches the second product identifier, the method further comprising:
determining, by the service provider system, that a dispensing date specified in the dispensing data record is chronologically after an effective date that the orphan drug data record was generated;
retrieving, by the service provider system, a set of one or more patient encounter data records included in the patient encounter data, wherein a respective patient medical record identifier included in each patient encounter data record matches a patient medical record identifier included in the dispensing data record; and
determining, by the service provider system, whether the set of one or more patient encounter data records includes a disqualifying patient encounter data record that specifies a patient encounter date that is more than a threshold period of time before a predetermined date and that includes a diagnosis code that corresponds to the designated condition.

9. The method of claim 8, wherein the set of one or more patient encounter data records includes the disqualifying patient encounter data record, and wherein the dispensing status identifier indicates the third dispensing status.

10. The method of claim 8, wherein the set of one or more patient encounter data records does not include the disqualifying patient encounter data record, the method further comprising:
identifying, by the service provider system, a particular patient encounter data record that includes a diagnosis code that corresponds to a condition other than the designated condition,
wherein the dispensing status identifier indicating the second dispensing status is generated responsive to determining identifying the particular patient encounter data record.

11. The method of claim 10, further comprising:
determining, by the service provider system, whether at least one eligibility criterion is satisfied for replenishing a quantity of the orphan drug dispensed as part of the drug dispensing event at a 340B price for the orphan drug.

12. The method of claim 11, wherein determining whether the at least one eligibility criterion is satisfied comprises:
determining, by the service provider system, that a patient status identifier included in the dispensing data record identifies an outpatient status for a patient to whom the orphan drug was dispensed; and
determining, by the service provider system, that a prescriber identifier included in the dispensing data record identifies a covered entity.

13. A system, comprising;
at least one memory storing computer-executable instructions; and
at least one processor configured to access the at least one memory and to execute the computer-executable instructions to:
receive orphan drug identification data, patient encounter data, and dispensing data;
identify a dispensing data record included in the dispensing data, wherein the dispensing data record corresponds to a drug dispensing event;
identify a first product identifier specified in the dispensing data record;
determine whether the first product identifier matches a second product identifier included in an orphan drug data record included in the orphan drug identification data;
generate a dispensing status identifier indicating one of: i) a first dispensing status indicating that the drug dispensing event is a dispensing of a non-orphan drug, ii) a second dispensing status indicating that the drug dispensing event is a dispensing of an orphan drug for a particular condition other than a designated condition for which the orphan drug is designated for treatment, wherein the orphan drug data record includes a description of the designated condition, or iii) a third dispensing status indicating that the drug dispensing event is a dispensing of the orphan drug for the designated condition;
store the status identifier in association with the dispensing data record; and
determine whether at least one eligibility criterion is satisfied for replenishing a quantity of a drug dispensed as part of the drug dispensing event at a 340B price for the drug if the dispensing status identifier indicates the first dispensing status or the second dispensing status.

14. The system of claim 13, wherein it is determined that the first product identifier does not match the second product identifier, and wherein the dispensing status identifier indicates the first dispensing status.

15. The system of claim 13, wherein it is determined that the first product identifier matches the second product identifier, and wherein the at least one processor is further configured to execute the computer-executable instructions to:
determine that a dispensing date specified in the dispensing data record chronologically precedes an effective date that the orphan drug data record was generated,
wherein the dispensing status identifier indicating the first dispensing status is generated responsive to a determination that the dispensing date chronologically precedes the effective date.

16. The system of claim 13, wherein it is determined that the first product identifier matches the second product identifier, and wherein the at least one processor is further configured to execute the computer-executable instructions to:
determine that a dispensing date specified in the dispensing data record is chronologically after an effective date that the orphan drug data record was generated;
retrieve a set of one or more patient encounter data records included in the patient encounter data, wherein a respective patient medical record identifier included in each patient encounter data record matches a patient medical record identifier included in the dispensing data record; and
determine whether the set of one or more patient encounter data records includes a disqualifying patient encounter data record that specifies a patient encounter date that is more than a threshold period of time before a predetermined date and that includes a diagnosis code that corresponds to the designated condition.

17. The system of claim 16, wherein the set of one or more patient encounter data records includes the disqualifying patient encounter data record, and wherein the dispensing status identifier indicates the third dispensing status.

18. The system of claim 16, wherein the set of one or more patient encounter data records, and wherein the at least one processor is further configured to execute the computer-executable instructions to:
identify a particular patient encounter data record that includes a diagnosis code that corresponds to a condition other than the particular condition,
wherein the dispensing status identifier indicating the second dispensing status is generated responsive to determining identifying the particular patient encounter data record.

19. The system of claim 18, wherein the at least one processor is further configured to execute the computer-executable instructions to:
determine whether at least one eligibility criterion is satisfied for replenishing a quantity of the orphan drug dispensed as part of the drug dispensing event at a 340B price for the orphan drug.

20. The system of claim 19, wherein the at least one processor is configured to determine whether the at least one eligibility criterion is satisfied by executing the computer-executable instructions to:
determine that a patient status identifier included in the dispensing data record identifies an outpatient status for a patient to whom the orphan drug was dispensed; and
determine that a prescriber identifier included in the dispensing data record identifies a covered entity.
